(19) United States
(12) Patent Application Publication
(10) Pub. No.: US 2002/0107730 A1
(43) Pub. Date: Aug. 8, 2002

(54) Method and apparatus for identifying customers for delivery of promotional materials

(76) Inventor: Robert Bernstein, Wilmette, IL (US)

Correspondence Address: Welsh & Katz, Ltd, Jon P. Christensen, 22nd Floor, 120 South Riverside Plaza, Chicago, IL, 60606, US

(21) Appl. No.: 09/777,098

(22) Filed: Feb. 5, 2001

(51) Int. Cl. G06F 17/60

(52) U.S. Cl. 705/14; 705/26

(57) ABSTRACT

A method and apparatus are provided for identifying potential customers for delivery of promotional materials. The method includes the steps of forming a customer profile by a vendor for targeting delivery of the promotional materials to potential customers, identifying customers which match the customer profile within a database of a third party and forwarding promotional materials to the identified customers.

### FIELD OF THE INVENTION

The field of the invention relates to advertising and more particularly to identification of potential customers for delivery of advertising materials.

### BACKGROUND OF THE INVENTION

The field of advertising and distribution of promotional materials is generally known. Typically, advertisers target a particular type of buyer and then search for a communication medium most likely to reach the targeted buyer. For example, upscale buyers may preferentially subscribe to particular magazines or listen to one particular radio station over others. By identifying a particular medium, the advertiser may be able to tailor an ad to have a maximum impact on the targeted buyer.

While such practices are effective, they are far from perfect. Mediums such as magazines are typically distributed nationally, yet many retailers only sell locally.

Other local mediums, such as radio or television, typically tailor their content to the broadest possible audience, thereby limiting an advertiser's ability to target a particular type of buyer. Further, the availability of streaming audio (or video) over the Internet virtually eliminate any regional limitations to radio or television broadcasting.

In addition, the use of the Internet for marketing has further increased the difficulty of targeting potential buyers for the distribution of advertising materials. The right to privacy further complicates the unrestricted distribution of buyer information to vendors.

While the distribution of advertising materials under the prior art is effective, it is extremely inefficient. Accordingly, a need exists for a better method of distributing promotional materials to potential buyers.

### SUMMARY OF THE INVENTION

A method and apparatus are provided for identifying potential customers for delivery of promotional materials. The method includes the steps of forming a customer profile by a vendor for targeting delivery of the promotional materials to potential customers, identifying customers which match the customer profile within a database of a third party and forwarding promotional materials to the identified customers.

### BRIEF DESCRIPTION OF THE DRAWINGS

FIG. 1 is a block diagram of a system for distributing promotional materials in accordance with an illustrated embodiment of the invention; and

FIG. 2 depicts a customer profile that may be used by the system of FIG. 1.

### DETAILED DESCRIPTION OF AN ILLUSTRATED EMBODIMENT

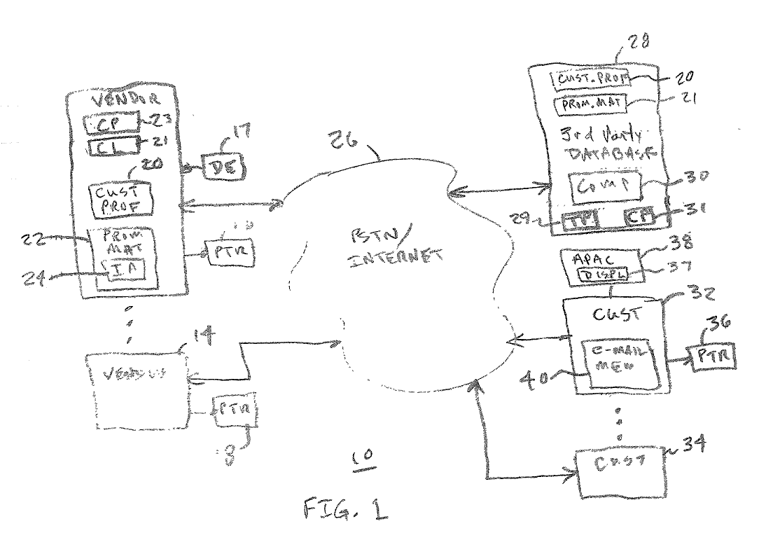

FIG. 1 is a block diagram of a system 10, shown generally, which allows vendors 12, 14 to identify potential customers 32, 34. While FIG. 1 shows two vendors 12, 14 and two customers 32, 34, it is to be understood that any number of vendors 12, 14 and any number of customers 32, 34 may be may be serviced by the system 10. Further, there is no limitation on geographic location. The only limitation is that the vendor 12, 14 and the customer 32, 34 have access to the public switched telephone network (PSTN)/Internet and a relationship with a third-party database 28.

The use of the system 10 allows vendors 12, 14 and customers 32, 34 to interact at any chosen level. Interactions may occur based upon a targeted locale, interest, or under any other chosen criteria.

The third-party database 28 may be any database which tracks financial transactions of buyers 32, 34 and which accepts customer search profiles from vendors 12, 14. The third-party database may be the third-party payment scheduler described in U.S. patent application Ser. No. 09/195,467, filed Nov. 28, 1998 by the inventor of the instant application or the tax record database of U.S. patent application Ser. No. 09/679,083, filed Oct. 4, 2000 by the inventor of the instant application (both incorporated herein by reference).

Under the illustrated embodiment, a customer (i.e., a buyer) 32, 34 may periodically interact with vendors 12, 14 directly, by face-to-face contact, or through the PSTN/Internet 26. Where the contact is face-to-face, payment may be made from the customer 32, 34 to the vendor 12, 14 for goods and services using the automatic portable account controller (APAC) 38 (e.g., a smartcard or the interactive device described in U.S. Pat. No. 5,591,949). Alternatively, the contact may be by telephone or through the Internet 26. In either case, a summary of the transaction may be generated and stored in the database 28.

Based upon the interactions between the customers 32, 34, and at least some of the vendors 32, 34, the database 28 may accumulate information regarding the buying preferences and habits of the individual customers 32, 34. Alternatively, the customers 32, 34 may request and complete a questionnaire of preferences and buying habits, which, in turn, may form a portion of the information within the database 28.

From time to time, a vendor 12, 14 (e.g., 12) may desire to expand its customer base by distributing promotional materials (e.g., coupons, special price lists, catalogs, etc.) to potential customers 32, 34. In order to identify potential customers, the vendor 12 may form a customer profile 20. The vendor (not shown) may form a customer profile using a data entry device 17 (e.g., a keyboard and display). Alternatively, a CPU functioning as a customer profiler 23 may analyze past sales to form a profile of customers which are likely to patronize the vendor 12.

The customer profile 20 may incorporate any of a number of limitations specific to the type of customer 32, 34. For example, if the vendor 12 markets locally, then the profile 20 may include a limitation that identified customers 32, 34 live in or have a history of purchasing in the locale where the vendor 12 sells. Further, the vendor 12 may include limitations that identified customers 32, 34 have previously purchased complementary products or services in the locale where the vendor 12 sells. For example, if a customer likes pizza, then a complementary product may be beer. Alternatively, if a customer 32, 34 purchases gas at a particular location, then complementary products may be convenience products offered through a convenience store in the area.

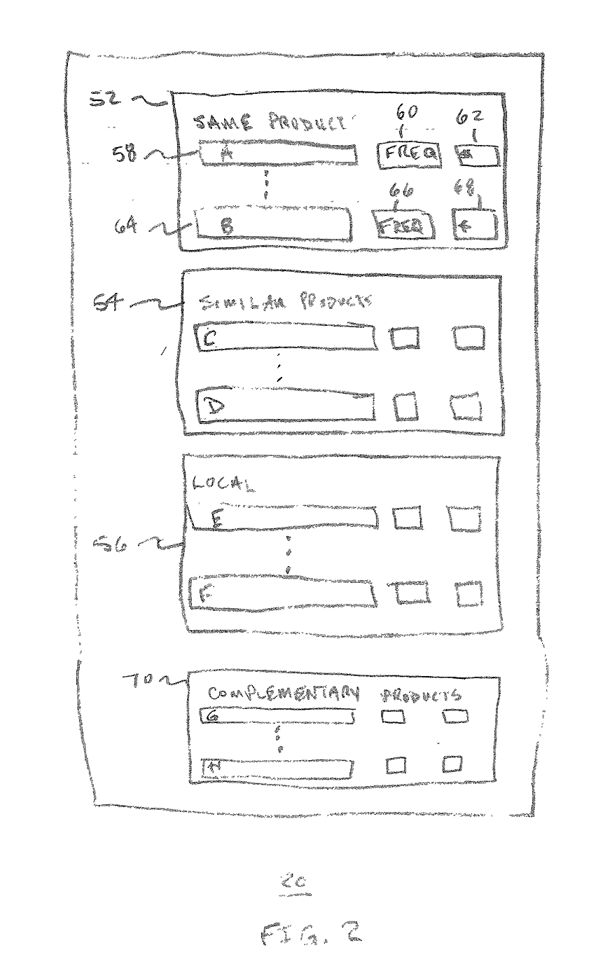

FIG. 2 provides a summary of a customer profile 20. Included within the customer profile 20 may be limitations including purchases of the same products 52, similar products 54 or a locale of purchases 56. Each limitation may include a minimum frequency of purchase 60, 66 or even a dollar value 62, 68.

Upon forming the customer profile 20, the vendor 12 may transfer the profile 20 to the database 28. Within the database 28, a comparator 30 may function to compare the profile 20 to the buying habits and other information of any of a number customers 32, 34. The database 28 may return a customer list 21 of the customers 32, 34 with the closes match to the requesting vendor 12.

In order to preserve the privacy of the customers 32, 34, the database 28 may release customer information to the vendor 12 in summary form only. For example, the database 28 may limit the release to contact information about identified customers 32, 34 which meet the limitations of the customer profile 20. The contact information (i.e., customer list 21) may be downloaded to the vendor 12.

Alternatively, customer privacy may be protected by uploading the promotional material 22 from the vendor 12 to the database 28. The database 28, in turn, may function to distribute the promotional material.

In either case, a communication processor 31 within the database 28 or vendor 12 may distribute the promotional materials 22 under any of a number of different formats. For example, where the contact information provides an e-mail address of the customers 32, 34 on the contact list 21, the database 28 or vendor 12 may send an e-mail to the customers 32, 34 on the customer list 21 containing the promotional materials 22.

To prevent fraud, the promotional materials may be customized for each customer on the customer list 21 by the addition of indicia of authenticity (e.g., a serial number) provided by the vendor 12. Where the promotional materials 22 were directly distributed to customers 32, 34 by the vendor 12 and then presented for redemption to the vendor 12, the vendor 12 may compare the indicia 24 with its own internal distribution list to determine authenticity. Alternatively, where a summary of the transaction is sent to the database 28, the database 28 may compare the indicia 24 with its own records to ensure that the indicia 24 was distributed to the customer 32, 34 presenting the materials 22 for redemption.

In the alternative, other methods may be used to distribute the promotional materials 22. For example, where the database retains the customer list 21, a transaction processor 29 within the database 28 may examine a customer identifier of each incoming purchase transaction. Where a match is found between the customer 32, 34 and an entry on the customer list 21, the database 28 may download the promotional material 22 directly to a printer 16, 18 of the vendor 12, 14.

Alternatively, the promotional materials 22 may downloaded to the APAC 38 at the point of sale. The customer may then scroll through and view the promotional materials as appropriate to the circumstance.

For example, where a first vendor 12 is offering the promotional materials 22 and a customer 32 makes a purchase from another vendor 14, a summary of the purchase may be sent to the database 28. The database 28 may compare a customer identifier from the summary of the purchase with the customer list 21. If a match is found, the database 28 may download the promotional materials 22 to the printer 18 of the vendor 14. The promotional materials 22, in fact, may be printed on the back of a sales receipt provided by the vendor 14 at the point of sale.

As a further example, consider a television (TV) vendor, a pizza store and a liquor store. A TV vendor, pizza store and liquor store are unlikely to market together. The TV vendor is a mass marketer, the pizza store would likely be small and local, and the liquor store is not likely to hook up with the pizza store, much less a TV vendor.

Consider a customer of the TV vendor, who is given promotional materials fore the other stores while buying a new TV. Alternatively, consider a customer of the liquor store being given a pizza or TV offer while buying beer. All of these scenarios are possible and appropriate when the consumer is hosting a party for watching a TV program (like the Superbowl or other sporting event). In the past, none of the three merchants would cross-promote because they didn't have the means or the information to do so. Prior art systems were unable to be highly targeted and offer real time promotional opportunities because their date was not integrated. If the TV is bought at “Best Buy” on a store charge, then it would be invisible to the credit card company. Cash purchases at the pizza store would also be left out. A check for the liquor store would similarly be left out of the loop.

In order to reach customers, vendors have used a “shotgun” approach to market for the masses (like Superbowl ads that are shown to everyone) or highly targeted narrow promotions that fail to reach their targeted market. (Print advertising or radio ads are not read or heard by everyone who the vendor would like to reach.) By integrating data from all modes of payment using the database 28, it is possible to efficiently market to a highly specific consumer at a time of purchase.

The distribution of promotional materials 22 at a point of sale may have great value in the case of transient customers. For example, the customer profile 20 may correlate the one-time check-in of a customer 32, 34 into a local hotel with distribution of promotional materials. In this way, a local eatery may notify a newcomer to the area of his establishment without the necessity of mass advertising. The promotional materials 22, as above, may be printed on the back of a receipt from the hotel or e-mailed to the customer for pick-up at his convenience at a convenient e-mail terminal (possibly provided by the hotel).

Under other illustrated embodiments, a customer 32, 34 may pay a monthly fee to the database 28 to be provided with promotional materials 22 that are specific to their overall buying histories. In this case, the customer 32, 34 may provide his own customer profile 20 of products which that customer 32, 34 may want to receive. The customer 32, 34 may receive the promotional materials by any appropriate medium (e.g., e-mail, direct mail, point of sale print-out, etc.).

Consumers are exposed to vast amounts of unsolicited and wasteful marketing. Using the system 10 described above, it is possible for a consumer to receive, or subscribe to a service that offers, highly specific buying opportunities.

On the vendor side, there is enormous efficiencies to be gained by using the integrated data of the database 28. These efficiencies translate into avoidance of advertising money and customer savings opportunities. Small vendors can find low cost, but highly effective, opportunities that are currently beyond their reach.

Under the system 10 described above, promotions may be based upon any of a number of prior purchases (e.g., checks, cash, tokens, store charges, accumulated points plans, credit card purchases, etc.). A customer of a toll road automatic payment system (e.g., I-Pass) who uses a bridge or toll road segment, can be given restaurant or motel promotions based on his payments, location, direction, and past motel or restaurant charges. These promotions can be for commonly used items like audio tapes of books or cellular phones that operate in cellular ranges that encompass an entire itinerary. Further, 3-g cellular phones may be provided in conjunction with GPS and the system 10 to provide enhanced promotions based upon geographic position.

A specific embodiment of a method and apparatus for providing promotional materials has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

What is claimed is:

1. A method of identifying potential customers for delivery of promotional materials, such method comprising the steps of:
forming a customer profile by a vendor for targeting delivery of the promotional materials to potential customers;
identifying customers which match the customer profile within a database of a third party; and
forwarding promotional materials to the identified customers.

2. The method of identifying potential customers as in claim 1 further comprising detecting a purchase by a customer of the identified customers.

3. The method of identifying potential customers as in claim 2 wherein the step of forwarding promotional materials further comprises printing out the promotional materials at a point of sale of the purchase.

4. The method of identifying potential customers as in claim 3 wherein the step of forwarding promotional materials further comprises printing out a coupon.

5. The method of identifying potential customers as in claim 1 wherein the step of forwarding promotional materials further comprises composing an e-mail to the identified customer.

6. The method of identifying potential customers as in claim 5 wherein the step of forwarding promotional materials further comprises providing indicia of authenticity within the promotional materials.

7. The method of identifying potential customers as in claim 1 wherein the step of forming the customer profile further comprises specifying a geographical locale of prior purchases made by the potential customers.

8. The method of identifying potential customers as in claim 1 wherein the step of forming the customer profile further comprises specifying a subject matter of prior purchases made by the potential customers.

9. An apparatus for identifying potential customers for delivery of promotional materials, such apparatus comprising:
means for forming a customer profile by a vendor for targeting delivery of the promotional materials to potential customers;
means for identifying customers which match the customer profile within a database of a third party; and
means for forwarding promotional materials to the identified customers.

10. The apparatus for identifying potential customers as in claim 9 further comprising means for detecting a purchase by a customer of the identified customers.

11. The apparatus for identifying potential customers as in claim 10 wherein the means for forwarding promotional materials further comprises means for printing out the promotional materials at a point of sale of the purchase.

12. The apparatus for identifying potential customers as in claim 11 wherein the means for forwarding promotional materials further comprises means for printing out a coupon.

13. The apparatus for identifying potential customers as in claim 9 wherein the means for forwarding promotional materials further comprises means for composing an e-mail to the identified customer.

17. The apparatus for identifying potential customers as in claim 13 wherein the means for forwarding promotional materials further comprises means for providing indicia of authenticity within the promotional materials.

18. The apparatus for identifying potential customers as in claim 9 wherein the means for forming the customer profile further comprises means for specifying a geographical locale of prior purchases made by the potential customers.

19. The apparatus for identifying potential customers as in claim 9 wherein the means for forming the customer profile further comprises means for specifying a subject matter of prior purchases made by the potential customers.

20. An apparatus for identifying potential customers for delivery of promotional materials, such apparatus comprising:
a data entry device adapted to form a customer profile by a vendor for targeting delivery of the promotional materials to potential customers;
a comparator adapted to identify customers which match the customer profile within a database of a third party; and
a communication processor adapted to forward promotional materials to the identified customers.

21. The apparatus for identifying potential customers as in claim 20 further comprising a transaction processor adapted to detect a purchase by a customer of the identified customers.

22. The apparatus for identifying potential customers as in claim 21 wherein the communication processor further comprises a printer adapted to print out the promotional materials at a point of sale of the purchase.

23. The apparatus for identifying potential customers as in claim 20 wherein the forwarding promotional materials further comprises indicia of authenticity provided within the promotional materials.

24. The apparatus for identifying potential customers as in claim 20 wherein the customer profile further comprises a geographical locale of prior purchases made by the potential customers.

25. The apparatus for identifying potential customers as in claim 20 wherein the customer profile further comprises a subject matter of prior purchases made by the potential customers.
